(19) United States
(12) Patent Application Publication
(10) Pub. No.: US 2021/0011614 A1
(43) Pub. Date: Jan. 14, 2021

(54) METHOD AND APPARATUS FOR MOOD BASED COMPUTING EXPERIENCE

(71) Applicant: Ambience LLC, Pacific Palisades, CA (US)

(72) Inventors: Samuel Gustman, Pacific Palisades, CA (US); Valerie Karno, Pacific Palisades, CA (US)

(21) Appl. No.: 16/924,073

(22) Filed: Jul. 8, 2020

Related U.S. Application Data
(60) Provisional application No. 62/872,674, filed on Jul. 10, 2019.

(51) Int. Cl. G06F 3/0484; G06F 3/01; G06F 3/16; G06F 16/2457

(52) U.S. Cl. CPC G06F 3/04847; G06F 3/011; G06F 2203/011; G06F 16/24575; G06F 3/16

(57) ABSTRACT

The system provides a method and apparatus for dynamically modifying a computing experience based on an existing or desired state or mood of the user. The system detects the state or mood of the user in one or more ways. In one embodiment the system uses detected biometrics and desires of the user and/or manual input by the user to determine state, mood, and the like. The biometrics and other data can be used to identify a present and/or desired change in mood or moods of the user and to modify parameters of a computing experience in response to the mood.

This patent application claims priority to U.S. Provisional Patent Application 62/872,674 filed on Jul. 10, 2019, which is incorporated by reference herein in its entirety.

### BACKGROUND OF THE SYSTEM

Computing devices are a major component of daily life. A user will have regular and repeated interaction with computing devices such as desktops, laptops, tablets, mobile devices, smartphones, smart TVs, watches, eyeglasses, VR and AR headsets, and the like. When using the computing device, the user will engage with apps, operating systems, browsers, web sites, games, communication applications, portals, and the like. We refer to this interaction as a “computing experience”. Many devices, operating systems, web sites, and applications provide a graphical user interface (GUI) and include tools that allow a user to customize the look and feel of the computing experience. For example, the user can choose colors, themes, sound levels, buttons, plug-ins, apps, and the like. However, the changes that a user makes are typically fixed until the user changes them again. In some cases, it is possible to randomly include images as part of the screen experience, but that is independent of the user and user activity.

Similarly, when a user interacts with an application, the look and feel of the application is generally fixed or limited to some customization “skins” or looks that the user can manually implement. Currently there is no ability to dynamically customize a computing experience based on the mood of the user.

### SUMMARY

The system provides a method and apparatus for dynamically modifying a computing experience based on an existing or desired state or mood of the user. The system detects the state or mood of the user in one or more ways. In one embodiment the system uses detected biometrics and desires of the user and/or manual input by the user to determine state, mood, and the like. The biometrics and other data can be used to identify a present and/or desired change in mood or moods of the user and to modify parameters of a computing experience in response to the mood. In one embodiment the system would use biometric mood monitoring devices (e.g. using the computer camera, fit bits, apple watch, spire health tag https://spire.io/ other biometric devices, and the like). After identifying the mood, the system can alert the user to a present mood, in service of letting the user pick an alternate mood to seek and to change the computing experience based on the present or selected mood.

In one embodiment, the user can indicate their state by responding to questions presented by the system. In one embodiment, the system may query the user with questions related to the five senses to identify the state of the user and to modify the system interaction accordingly. In one embodiment the system may automatically detect the state of the user via biometrics, imaging devices, and the like. In one embodiment, the system may detect the state of the user based on user activity, searches, response time, and the like.

After the user state is detected, the system can be used to modify the look and feel of the computing experience, the environmental factors of an application, browser, web site, device, and the like, and also be used to modify the actual processing and output of the computing experience. For example, in a browsing environment, the system can modify the browser software itself and/or modify search results based on the mood factors and metrics of the user. In one embodiment, the system will change UI colors and looks to match, elevate, change, and/or complement the mood of the user. In one embodiment, the system will provide a unique and custom animated environment based on the identified mood. In one embodiment, the system will provide a different type, number, and/or presentation of search results based on the user state.

### BRIEF DESCRIPTION OF THE DRAWINGS

FIG. 1 is a flow diagram illustrating automatic sensing of user mood in an embodiment of the system.

FIG. 2 is a flow diagram illustrating manual indication of user mood in an embodiment of the system.

FIG. 3 is a flow diagram illustrating changing a computing experience in response to a user mood in an embodiment of the system.

FIG. 4 is a flow diagram illustrating the system in implementing a desired user mood in an embodiment.

FIG. 5 illustrates an embodiment of the system.

FIG. 6 illustrates an example computer embodiment of the system.

### DETAILED DESCRIPTION OF THE SYSTEM

The system modifies a computing experience and, in one embodiment, performance and results of applications, based on biometrics and other data associated with the user. In one embodiment the system utilizes biometric mood monitoring devices (e.g. using the computer camera, fit bits, apple watch, spire health tag https://spire.io/ other biometric devices, and the like) to collect related data. The data obtained is used to predict and/or determine a mood of the user and to modify the computing experience accordingly. The system has application to any computing experience, using any computing device, and including applications, operating systems, interfaces, operational features, environmental options, browsers, and the like.

In one embodiment, the system defines seven moods, each of which can have multiple states. The moods are Excitement, Stability, Happiness (Sad to Joyous), Emotion (Loving to Angry), Contentment (Satisfied to Frustrated), Well Being (Relaxed to Tense) and Attitude (Confident to Afraid). It should be noted that the system can be implemented with more, fewer, or other moods and states as desired. In one embodiment, each state of each mood has associated color, pace, sound, and other modifications to the user experience. Other modifications include mapping product search results to rating or Quality of Product (4-star, 5-star, credibility) with the understanding that knowing makes a user less anxious, could be used in the soothing state for example. Other modifications include linking search results to other expanded searches (Increasing Possibilities for increased Excitement or Joy); mapping mood-based ads or event notifications or stimuli which can enhance manifestations of senses linked to moods).

The following are examples of mood, states, and settings for color, sound, and pace.

1. Excitement

State 1 (Soothing):

Color: Cool pale Blue;

Pace: Very Slow (1-2 on scale of 1-10); Search: sets of content you can scroll through; Use images rather than Keywords of/or Text

Sound: Monotone steady, quiet

State 2 (Calm):

Color: Pale Lavender

Pace: Slow (3-5 on scale of 1-10);

Sound: Two-tones, oscillating, or repetitive ocean Waves, medium volume

State 3 (Excited):

Color: Multicolors with sample of brighter colors (orange, red, green, pink, yellow) mixed in;

Pace: Quick (6-8 on scale of 1-10);

Sounds: clapping, kids laughing,

State 4: (Agitated):

Colors: Many Intense and Bright Colors on Screen (White, Red, Black, Neons);

Pace: Very Fast (9-10 on scale of 1-10)—rapidly changing colors, sounds, images

Sounds: Loud, clanging, banging, screeching (cars braking, dishes slamming, heavy metal guitar)

2. Stability:

State 1: (Stability)

Color: Darker Brown, olive green, teal

Pace: Steady, even change (3-6)

Sound: Monotone

State 2: (Somewhat Balanced)

Color: Tans/Neutrals

Pace: Some changes in tempo (Steady (3-6), then changing more rapidly (8), then Steady)

Sound: Some high notes, some low notes, variable multi-instrument music (light jazz)

State 3: (Mildly Uncomfortable)

Color: Light yellow, yellow-green, Dark Orange, rusty red

Pace: Somewhat quick (6-8 out of 10)

Sound: contrasting sounds which don't harmonize in sequence

State 4: (Uncomfortable/Unstable)

Color: Dark Red, Black,

Pace: Varying between slow (1-2), and Fast (8-10)

Sound: Varying between monotone Ominous tone, and frenetic atonal, and multi-instrument shifts

3. Happiness (Sad-Joyous)

State 1 (Grieving):

Color: Deep purple and dark blue

Pace: Slow to mildly slow (1-5 on scale of 1-10)

Sound: Strong/Intense Harmonious, key of G, C, Ds.

State 2 (Mildly Sad):

Color: Green (middle green)

Pace: Mildly slow (3-7 on scale of 1-10)

Sound: A few instruments (acoustic-electric, bass, cello, violin), nature: Windy leaves falling

State 3 (Mildly Happy):

Color: Yellow-Orange/Gold

Pace: Steady, Solid (3-7 on scale of 1-10)

Sound: Light wind instruments (flute), birds chirping, nature: streams flowing

State 4 (Joyous):

Color: Bright yellow background with smaller multicolor bright colors within

Pace: Middle (5 on 1-10 scale)

Sound: Moving from Lighthearted to Monotone “AHHHH” in background like hallelujah church music;

4. Emotion (Loving-Angry)

State 1 (Loving)

Color: pale green, lavender

Pace: steady repetition

Sound: harmonious sounds

State 2 (Feeling Love but could benefit from tapping into more)

Color: yellow, pale orange, light blue

Pace: varied: not quick, but not steady

Sound: mixed sounds, switching to find the right one

State 3 (Displeased)

Color: Darker Orange/Red combo, some dark blue,

Pace: Faster (6-8)

Sound: More intense and complicated music

State 4 (Angry)

Color: Orange-Red/Dark Red

Pace: Fast, Increasing Heart Rate

Sound: Strong, Loud, Pounding

5. Contentment (Satisfied to Frustrated)

State 1: (Satisfied)

Color: Forest and Tree Greens, tan

Pace: Steady (2-4 change rate)

Sound: Background sounds which don't disrupt: choices can include:

a. Ocean waves

b. Flute music or Sitar

State 2: (Content but looking for something)

Color: olive green, teal

Pace: Steadily changing (4-7 change rate)

Sound: Sounds will vary with choice between:

a) rustling leaves/mild wind in nature

b) jazz improvisation

State 3: Dissatisfied

Color: Burnt yellow-orange, colors mixed which look wrong (Purple and brown, i.e.), Dark Grey

Pace: Quick (6-8 change rate)

Sound: Slightly irritating sounds: dogs barking, gum being chewed loudly, atonal music

State 4: Frustrated (with gap between desire and lived experience)

Color: Intense colors of discord against each other: black against red, grey against orange; Jackson Pollack type canvases; white against colors

Pace: Quick

Sound: Heavy metal guitar, city noises like cars honking, loud voices,

6. Well Being (Relaxed to Tense)

State 1: Relaxed

Color: Sky blue

Pace: Middle (3-5)

Sound: wind chimes, gentle music

State 2: A Bit Stressed

Color: yellow-orange

Pace: Mid-High (4-7)

Sound: Mildly annoying sounds

State 3: Too Stressed

Color: Grey

Pace: Mid-High (5-8)

Sound: Sounds that aggravate

State 4: Tense

Color: Black, Red

Pace: Prolonged—of any image

Sound: Mono-sound, scraping, irritating sounds

7. Attitude (Confident to Afraid)

State 1: Confident

Color: Gold, Dark Blue, Purple

Pace: Steady (3-4)

Sound: Strong but gentle background noise

State 2: Unsure but ok

Color: Amber, blue-green

Pace: Mid-Range (3-6)

Sound: Mostly steady with some intermittent unsettling sounds

State 3: Nervous

Color: Dark Orange, Gray

Pace: Mid-High (7-9)

Sound: Short sounds, not that make you jump, but quick enough to keep disrupting and making uncomfortable

State 4: Afraid

Color: Pink, Red

Pace: Quick (8-10)

Sound: Sudden noises, jerky sounds

Automatic Sensing of User Mood

In one embodiment, a processing system is used to automatically collect data about the user and to use that data to estimate, predict, or determine the mood or state of the user. FIG. 1 is a flow diagram of the automatic sensing process in an embodiment of the system. The processes described in steps 101, 102, 103, and 104 may be used alone or in any combination in embodiments of the system. It is not required that any or all be used, but they may all be used in an embodiment. The system may detect the mood of the user as described above, and/or the state of the user in one of the moods.

At step 101 the system obtains image data of the user. This may be via a camera integrated into the processing system, such as built in computer camera, phone camera, laptop camera, or via an add-on camera that is part of the system. The camera may capture one or more still images of the face of the user, and/or may capture video of the face of the user. The system may identify possible mood indicators including smiling, frowning, red eyes, skin tone, and the like, which the system can use as mood indicators. The system can also monitor activity using the image capturing device, including inattention, yawning, itchiness, coughing, sneezing, and the like, all of which can provide information as to user mood.

In other embodiments, the system may capture the upper torso and head of the user (e.g. when the user is sitting at computer) and determine the posture of the user (e.g. slumping, erect, tilted, agitated movement, and the like). The system may use the image data (alone or with metrics from one or more from the other steps) to determine or predict user mood.

The system may keep a database of previous images of the user along with state and mood data. The system may use a histogram to identify a plurality of characteristics of the captured image(s) that can be used to aid in identifying a mood of the user. The system may use artificial intelligence (AI) to help the system learn to read the user more effectively. In one embodiment, the user may confirm or correct a mood suggested by the system, providing calibration information for the system to improve performance.

At step 102 the system obtains biometric data. This may be obtained from various devices used by the user, such as fit-bits or other fitness tracking devices, smart watches, health tags; patient monitoring devices, and the like. The biometric data may include, but is not limited to, heart rate, blood pressure, body temperature, blood oxygenation; blood sugar, perspiration, respiration rate, and the like. The biometric data can be used (alone or with metrics from one or more of the other steps) to help determine or predict user mood.

At step 103, the system collects weather and other environmental data, including time of day, day of week, time of year, and the like. The system can use this data to determine a possible mood of the user. If the user is working early, late, on a weekend, or on a holiday, the system may predict anxiousness, sadness, impatience, or the like in the user mood. If the weather is rainy, cold, excessively hot, or just generally unseasonable, the user mood may be affected. Similarly, if the weather is pleasant, the user mood may be impacted. The system may even scan national and local news feeds to determine if there are external factors that could affect the mood of the user. For example, if a local sports team has been recently successful, the mood or state of the user may be affected. If an important tour, exhibit, presentation, lecture, or the like is announced, the user's mood could be affected.

At step 104, the system monitors and collects activity data of the user. This includes typing speed, sites visited, response times, applications and programs selected, mouse motion, gestures, accelerometer data, battery level, and the like. The system can use these metrics (alone or with metrics from one or more of the other steps) to help determine a mood of the user.

At step 105 the system analyzes the data obtained in one or more of steps 101, 102, 103, and 104. This may include weighting the data retrieved, assigning a numeric value to the data, using a histogram to analyze the data, or using an algorithm to analyze the data. Examples of some methods of detecting mood include apps such as Daylio, MoodKit, eMoods, aiMei, iMoodJournal, and the like.

At step 106, based on the analysis, a possible mood of the user is determined. For example, if the user has a low pulse rate, is yawning, slow movement, low blood oxygenation and the like, the system may determine that the user is tired. Rapid pulse, dilated pupils, high respiration rate, and the like may indicate excitement. A person can be tense, with clenched teeth, irregular breathing, and turn to serene or relaxed with quiet, regular breathing and facial strain removed; A person can be uncomfortably sad or lonely, with drooped, teary eyes and hunched body position, and move to more joyful connection indicated by hopeful body posture, eye position, and less lethargic movements. In one embodiment, the system optionally presents the possible mood to the user for confirmation.

At step 107, the system has determined the user mood and modification of the computing experience can be implemented. In one embodiment, the mood analysis is done when a computing session begins (e.g. if there has been a threshold time period between use of the computing system, such as 15 minutes or a half hour). In one embodiment, the system continuously or periodically monitors user mood and updates or modifies the computing experience accordingly.

Manual Determination of Mood

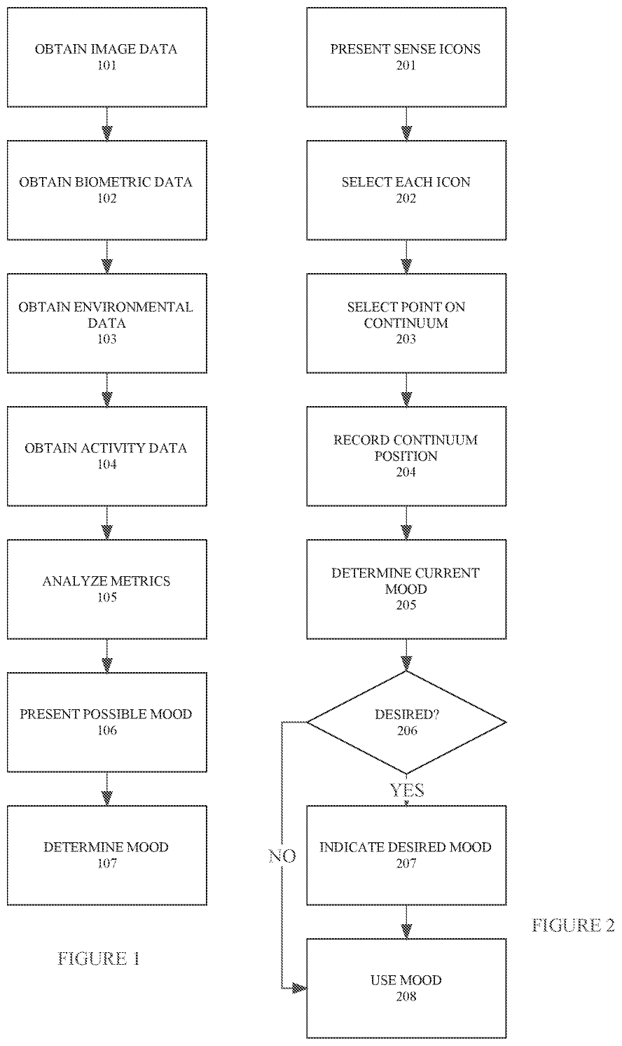

In one embodiment, the user may indicate state or mood by indicating it directly and/or by responding to queries provided by the system. FIG. 2 is a flow diagram illustrating the manual determination of mood in an embodiment of the system. In the example of FIG. 2, only one mood is identified. It will be understood that the system may identify more than one state or mood without departing from the scope and spirit of the system. In addition, the user may respond to the queries based on a present mood, or a desired future mood. In this manner, the system may help the user achieve the desired mood by altering the experience accordingly.

At step 201 the user is presented with five icons on the display of the processing system. Each icon represents one of the five senses and queries the user about each sense. For example, the icons can query (“How Do Things Look Today?”) (How Do Things Feel Today?) (“How do Things Sound Today?”) (“How Tasty are things today?) (“How Does the World Smell Today?”). At step 202, the user selects each icon.

In one embodiment, the selection of each icon presents the user with an indicator of a continuum associated with the sense. For example, for sight or vision, the system may provide a plurality of continuum choices such as:

### Empty-Cluttered

### Clean-Dirty

### Monochromatic-Colorful

### Uninhabited-Full of Creatures

### Barren-Tropical

For sound, the system may present the following:

### Quiet-Loud

One instrument-Many instruments

### Acoustic Music-Electric Music

### Traditional-Avant Garde

### Natural Sounds-Urban Sounds

Harmonious-Hands over Ears

### Background Sound-All Encompassing

For smell, the system may provide a continuum, with distinct choices representing points on the continuum, as shown below.

Neutral-Fragrant:

Floral

Fruity

Herbal

Oceanic

Pine Forest

Redwood Forest

City Center

Gym

New Car

New Paint

Restaurant with Grill

Restaurant with Fryer

Clean like a mall

Horse Stable

Farm

Swimming Pool

For touch the system may provide:

1) Soft (like a soft blanket)-Hard (like steel)

2) Silky (like pajamas)-Rough (like small rocks or stubble)

3) Squishy (like slime)-Flat (like a tv edge)

4) Textured (like corduroy or bumpy fabric)-Smooth (no ridges)

5) Fuzzy (like socks or a pet)-Sleek (like a car hood)

For taste the system may provide:

### Mild-Spicy

### Bland-Flavorful

### Drinkable-Chalky

Crunchy like a chip-Squishy like a gummy bear

### Salty Not Salty

Juicy (like ripened fruit)-Dry

### Bitter/Tart-Sweet

The system may provide a slider for the user to indicate, for each choice, where on the continuum the user feels is appropriate at step 203. The user may feel mostly colourful, but perhaps not fully colourful for example. The system can record the position on the continuum for each choice and for each sense at step 204. At step 205, the system uses the numeric value of all of the choices to determine the current mood and/or state of the user.

In one embodiment, the system may, in addition to the five sense icons, provide more specific mood indicators that the user can select. In one embodiment, the mood indicators can also be on a continuum and the user can select a point on the continuum. Examples include:

Excitement:
Soothing-Calm-Excited
Gentle-Agitated

Kindness:
Kind-Cruel

Pleasure:
Dull-Titillating

Stability:
Balanced/Stable-Uncomfortable/Change my Center

Sad-Joyous

Loving-Angry

Satisfied-Frustrated

Focused-Diffused

Slow-Frenetic (Slow-Moderate-Fast-Frenetic)

Pausing-Diving In

Connected-Disengaged

Relaxed-Tense

Serene-Frazzled

Conventional-Outlandish

Attentive-Distracted

Confident-Nervous

Energized-Fatigued

Disheartened-Optimistic

Shy-Outgoing (I want to hide/I want to take the world by storm)

It should be noted that whether automatic sensing is used, manual input, or some combination, the system may check mood upon login, periodically throughout the day, randomly, or in response to a request by the user. The timing could range from minutes to real time.

At decision block 206 it is determined if the user wishes to change a current mood to a desired mood. If so, the user indicates the desired mood at step 207 and the system uses that mood at step 208. If the user does not wish to change to a desired mood at step 206 the system uses the current mood at step 208.

Computing Experience Modification

Once the mood is determined or selected, the system can then modify the computing experience based on the results of the process of FIG. 2. The system can change the computing experience to match the user mood. Alternatively, the system can change the computing experience to guide the user to a desired mood.

Matching User Mood

The system can change the entire computing experience to match the user's mood. This can include modifying the user interface (colors, audio volume, iconography, menus, and the like) to match the user mood. This can be a modification of the user interface of the device operating system, an application, a browser, or a website. The system can also modify the behaviour or performance of an application, operating system, browser, website, and the like.

In one example, consider a user is doing a search using a browser. If the searcher is perceived to be anxious based on the user mood identification, the search results could be pared down to a fewer number of results so the searcher could analyze the results more quickly or be less overwhelmed with search results. In another example, a depressed searcher may be presented with the same search results but with warmer color accents and UI to improve the mood. In one embodiment, searches that might have accurate but unrelated results will be edited to present results that more closely match a present or desired mood of the searcher. In one embodiment, the searcher could manually enter their mood as desired. Search results can attend to the user's desires. In addition to modifying the presentation of the search results, the system could modify the ads that are served that would be optimized for the mood of the searcher.

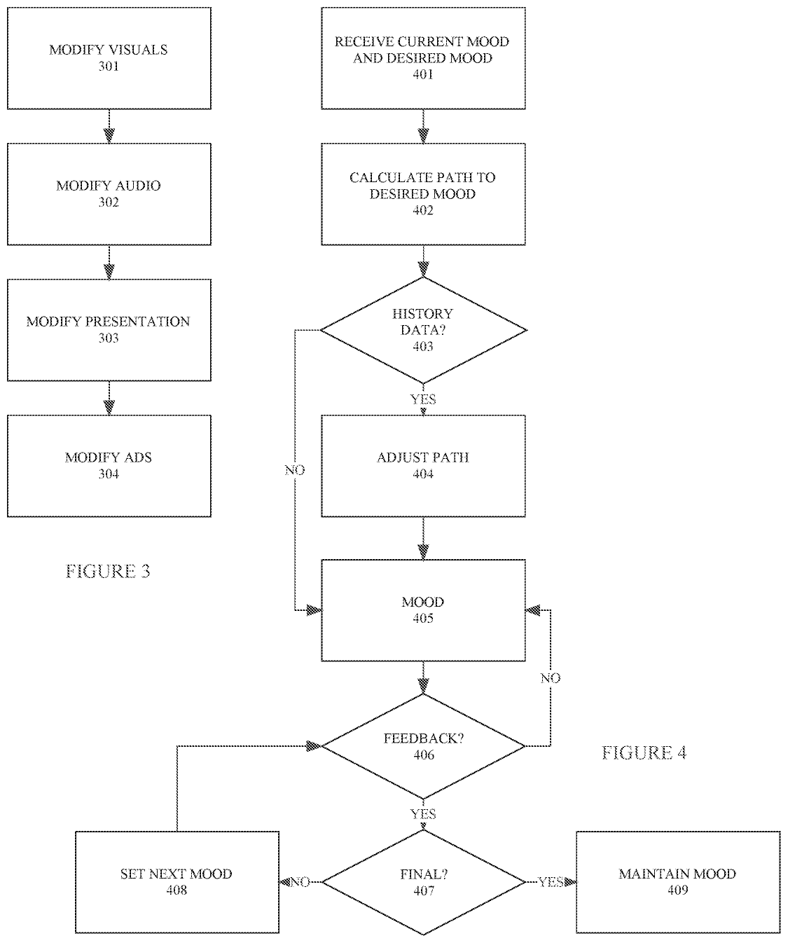

The system modifies the processing experience and interaction based on the current or desired mood of the user. There are a number of modifications that can be made. FIG. 3 is a flow diagram illustrating the modification of the processing experience in an embodiment of the system. At step 301 the system modifies the visual aspects of the system. In one embodiment, the color of the display or theme can be changed in response to the user mood. For examples, soothing colors could be used for an agitated or nervous user. By contrast, high energy colors could be used for a sleepy or tired user.

In addition to changing colors, the system can change themes dynamically as well. For example, some themes might have continuous movement using animations, while others would be still or slowly moving. Some interfaces might be busy while others can be simplified and more spartan.

The interface graphics can be changed as well, such as with black and white images, sepia toned, subdued, saturated colors, and the like. In addition, the images themselves may be cityscapes, naturescapes, sports related, active scenes, passive scenes, eating, relaxing, solo people, crowds, families, animals, cold weather, warm weather, and the like.

At step 302, the system modifies the audio of the processing experience in response to the user mood. The system may play music or sounds as appropriate based on the mood of the user. In some cases, the system will not play any sounds. Loudness or Quietness can be modified for any background surroundings; Cumulative quantity of background noises can be controlled for variety of sounds running simultaneously or singular sounds dominating the auditory frame. The tempo of changing or stable sounds can also be adjusted to create to repetition or alteration of the sound content. The system may block the playing of audio in autostarting ads, or set a maximum volume for any audio from the system. If the user is in a high energy mood, the system may play high energy music or permit higher volume of audio during the computing experience.

In one embodiment, the system may add background audio to the user system to reinforce or reflect the mood. There are a number of apps that can provide such audio such as myNoise, Naturespace, Coffitivity, OmmWriter, and the like.

At step 303 the system modifies the presentation of the processing system. For example, if the user is doing a search using a browser, the number of results that appear may be modified depending on the user mood. For a neutral mood, the system may appear as is typical. If the user is angry, agitated, restless, confused, and the like, the system may only present the first two or three search results, allowing the user to more easily focus and not have the processing system provide additional stress or distraction. The system may limit sponsored content and only present the actual search results. SEO (Search Engine Optimization) may be modified based on the user mood. For example, when looking up a hotel, the first several pages or results are often booking sites for the hotel, and not the hotel itself. The system could filter out all booking sites and provide just the hotel website. In one embodiment, the booking sites remain, but the hotel website is presented as the first search result.

At step 304, the system can serve ads based not only on the history of the user, but on the current or desired mood or mood of the user as well. This ad targeting based on mood can be effective in providing products and services that the user might be more receptive to based on the user mood. For example, a tense user might respond positively to an ad for massage therapy, books on relaxation, and the like. A high energy user might respond well to ads for activities, travel, sports equipment, and the like. There might be an ad for pets for someone who is depressed, or vacations for someone who is anxious.

Desired User Mood

The system may help move a user from a current mood to a desired mood. In one embodiment, the system may simply present the same adjustments for the desired mood as if it were the current mood of the user. In one embodiment, the system determines a series of changes to the computing experience based on the current mood of the user and the desired mood, taking the user through a series of system adjustments to achieve the desired mood.

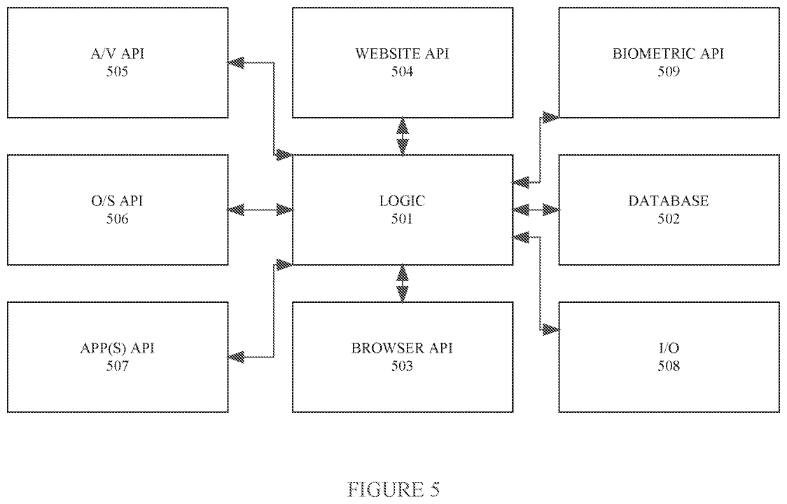

FIG. 4 is a flow diagram illustrating the system in implementing a desired user mood in an embodiment. At step 401 the system receives the current mood of the user and the desired mood. At step 402, the system calculates a path to move from the current mood to the desired mood. This path may comprise one or more intermediate moods through which the user is moved to achieve the desired mood. The system may have a stored database of all possible mood pairs and assign a cost value to the movement between two pairs of moods. This cost value may be the time of transition between moods, or any other suitable metric that will reflect the ease of moving between a first mood and a second mood. The system may update these scores based on historical data of all users in the system.

Using this information, the system can then plot a path from the current mood to the desired mood, seeking to minimize the number of transition moods while also seeking to reduce the total time taken to achieve the desired mood. In one embodiment, the use of fewer transition moods is given higher priority than the total time of transition.

At decision block 403, the system determines if there is any historical data for the User in moving from the current mood to the desired mood, or other historical data about this user's mood transitions that might aid in the determination of the best path between moods for this user. If there is historical data that indicates that the path should be modified, the system proceeds to step 404 and adjusts the path from mood to mood.

If there is no useful historical data at step 403, or after step 404, the system proceeds to step 405 and the system is adjusted for the first mood of the path. The adjustments in this transition process may incorporate all or some of the adjustments that would be made in FIG. 3.

At decision block 406, the system determines if there is feedback that indicates the user has transitioned sufficiently to move to the next mood in the path. This may be determined automatically via biofeedback as noted above, or via direct input from the user. If the user has not transitioned to the current mood on the path, the system returns to step 405.

If the user has transitioned to the current mood on the path, the system proceeds to decision block 407 to determine if the current mood is the final mood. If not, the system proceeds to step 408, selects the next mood in the path, and adjusts the computing experience accordingly and then proceeds to step 406. If so, the system moves to step 409 and maintains the current mood as the final desired mood.

System

The system is implemented as an application in an embodiment. The system application can be utilized on any computing device, including desktops, laptops, tablets, smartphones, smart watches, Internet of Things (IOT) and the like. The system may be resident on a device or may be accessed via network from the cloud. In embodiment, the system is implemented as a search bar that can be added to a user system.

FIG. 5 is a functional representation of the system application in an embodiment. The system application includes Logic 501 that provides the method of determining mood and controls the modification of the computing experience on a device in response to the mood of the user. The Logic 501 is coupled to a Database 502 that stores User profile and historical data along with historical data from other users, along with information about mood calculation and mood transition. Logic 501 is in communication with, and coupled to, the other functional logic elements of FIG. 5.

I/O 508 provides access to the system application for updating, environmental data; and the like. Biometric API (Application Programming Interface) allows the system application to access biometric data when available from user devices such as smart watches, sensors, thermometers, sleep data from smart beds, and the like. Browser API allows the system application to modify the computing experience of a browser, including the GUI, searching, sorting, search presentations, and the like.

Website API allows the system application to modify the computing experience of a website such as YouTube, Facebook, Twitter, news sites, shopping sites, and the like. App(s) API 507 allows the system application to control the computing experience of an app on a device, such as word processing software, mail and calendar software, and the like. O/S API 506 allows the system application to modify the computing experience of the user device by modifying the actions of the operating system. A/V API 505 allows the system application to access audio and video processes of the user device, both to collect data (e.g. image and video data) and to control the computing experience by controlling volume and the like.

Example Processing System

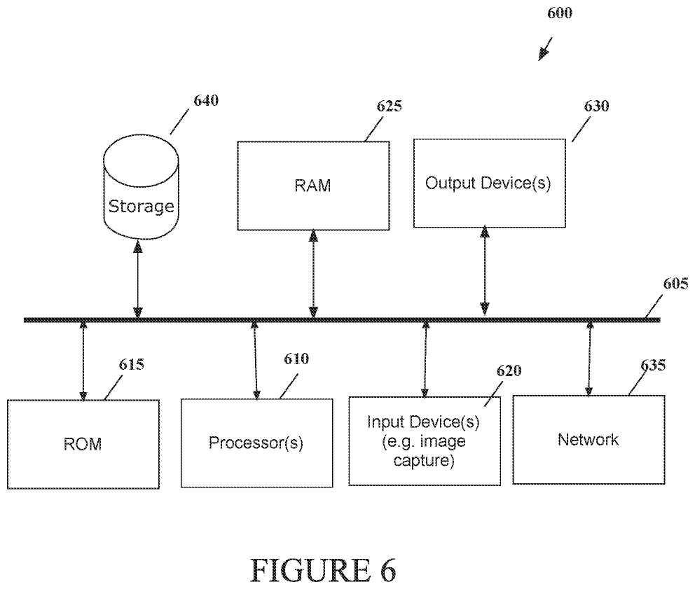

FIG. 6 illustrates an exemplary system 600 that may implement the system. The electronic system 600 of some embodiments may be a mobile apparatus. The electronic system includes various types of machine-readable media and interfaces. The electronic system includes a bus 605, processor(s) 610, read only memory (ROM) 615, input device(s) 620, random access memory (RAM) 625, output device(s) 630, a network component 635, and a permanent storage device 640.

The bus 605 communicatively connects the internal devices and/or components of the electronic system. For instance, the bus 605 communicatively connects the processor(s) 610 with the ROM 615, the RAM 625, and the permanent storage 640. The processor(s) 610 retrieve instructions from the memory units to execute processes of the invention.

The processor(s) 610 may be implemented with one or more general-purpose and/or special-purpose processors. Examples include microprocessors, microcontrollers, DSP processors, and other circuitry that can execute software. Alternatively, or in addition to the one or more general-purpose and/or special-purpose processors, the processor may be implemented with dedicated hardware such as, by way of example, one or more FPGAs (Field Programmable Gate Array), PLDs (Programmable Logic Device), controllers, mood machines, gated logic, discrete hardware components, or any other suitable circuitry, or any combination of circuits.

Many of the above-described features and applications are implemented as software processes of a computer programming product. The processes are specified as a set of instructions recorded on a machine-readable storage medium (also referred to as machine readable medium). When these instructions are executed by one or more of the processor(s) 610, they cause the processor(s) 610 to perform the actions indicated in the instructions.

Furthermore, software shall be construed broadly to mean instructions, data, or any combination thereof, whether referred to as software, firmware, middleware, microcode, hardware description language, or otherwise. The software may be stored or transmitted over as one or more instructions or code on a machine-readable medium. Machine-readable media include both computer storage media and communication media including any medium that facilitates transfer of a computer program from one place to another. A storage medium may be any available medium that can be accessed by the processor(s) 610. By way of example, and not limitation, such machine-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a processor. Also, any connection is properly termed a machine-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects machine-readable media may comprise non-transitory machine-readable media (e.g., tangible media). In addition, for other aspects machine-readable media may comprise transitory machine-readable media (e.g., a signal). Combinations of the above should also be included within the scope of machine-readable media.

Also, in some embodiments, multiple software inventions can be implemented as sub-parts of a larger program while remaining distinct software inventions. In some embodiments, multiple software inventions can also be implemented as separate programs. Any combination of separate programs that together implement a software invention described here is within the scope of the invention. In some embodiments, the software programs, when installed to operate on one or more electronic systems 600, define one or more specific machine implementations that execute and perform the operations of the software programs.

The ROM 615 stores static instructions needed by the processor(s) 610 and other components of the electronic system. The ROM may store the instructions necessary for the processor(s) 610 to execute the processes provided by the system. The permanent storage 640 is a non-volatile memory that stores instructions and data when the electronic system 600 is on or off. The permanent storage 640 is a read/write memory device, such as a hard disk or a flash drive. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer.

The RAM 625 is a volatile read/write memory. The RAM 625 stores instructions needed by the processor(s) 610 at runtime, the RAM 625 may also store the real-time video or still images acquired by the system. The bus 605 also connects input and output devices 620 and 630. The input devices enable the user to communicate information and select commands to the electronic system. The input devices 620 may be a keypad, image capture apparatus, or a touch screen display capable of receiving touch interactions. The output device(s) 630 display images generated by the electronic system. The output devices may include printers or display devices such as monitors.

The bus 605 also couples the electronic system to a network 635. The electronic system may be part of a local area network (LAN), a wide area network (WAN), the Internet, or an Intranet by using a network interface. The electronic system may also be a mobile apparatus that is connected to a mobile data network supplied by a wireless carrier. Such networks may include 3G, HSPA, EVDO, and/or LTE.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order and are not meant to be limited to the specific order or hierarchy presented.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other apparatuses, devices, or processes. Thus, the claims are not intended to be limited to the various aspects of this disclosure but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 18(f) unless the element is expressly recited using the phrase “means for” or, in the case of a method claim, the element is recited using the phrase “step for.”

Thus, a method and apparatus for dynamically modifying a computing experience has been described.

What is claimed is:

1. A method for modifying a computing experience comprising:
identifying a mood of a user of the computing experience;
identifying one or more modifications of the computing experience based on the identified mood to achieve a target computing experience;
making the one or more modifications of the computing experience to achieve the target computing experience.

2. The method of claim 1 wherein the mood of the user is identified by collection and analyzing biometric data of the user.

3. The method of claim 1 wherein the mood of the user is identified by having the user select a setting on an on-screen display.

4. The method of claim 1 wherein the target computing experience represents a goal mood of the user.

5. The method of claim 4 wherein the computing experience is modified to change the identified mood of the user to the goal mood.

6. The method of claim 1 wherein the modification to the computing experience comprises changing the GUI of the computing experience.

7. The method of claim 1 wherein the modification to the computing experience comprises modifying the audio of the computing experience.

8. The method of claim 1 wherein the modification to the computing experience comprises modifying the speed of performance of the computing experience.

9. The method of claim 1 wherein the computing experience comprises a search.

10. The method of claim 9 wherein the modification to the computing experience comprises modifying search results of the search based on the mood of the user.

11. A method of modifying a computing experience comprising:
identifying one of a plurality of moods of a user of the computing experience;
identifying one of a plurality of states of the identified mood;
identifying modifications in the color, audio, pace, and performance of the computing experience based on the identified mood and identified state to achieve a target computing experience;
modifying the color, audio, pace, and performance of the computing experience to achieve the target computing experience.

12. The method of claim 11 wherein the mood and state of the user are identified by collection and analyzing biometric data of the user.

13. The method of claim 11 wherein the mood and state of the user is identified by having the user select a setting on an on-screen display.

14. The method of claim 11 wherein the target computing experience represents a goal mood and state of the user.

15. The method of claim 14 wherein the computing experience is modified to change the identified mood and state of the user to the goal mood and state.

16. The method of claim 11 wherein the computing experience comprises a search.

17. The method of claim 16 wherein the modification to the computing experience comprises modifying search results of the search based on the mood and state of the user.
